(19) United States
(12) Patent Application Publication
(10) Pub. No.: US 2007/0252953 A1
(43) Pub. Date: Nov. 1, 2007

(54) Crosstalk reduced stereoscopic viewing apparatus

(76) Inventors: Robert Metzger, Fairport, NY (US); David Kessler, Rochester, NY (US); Joseph R. Bietry, Rochester, NY (US)

Correspondence Address: Mark G. Bocchetti;Patent Legal Staff, Eastman Kodak Company, 343 State Street, Rochester, NY, 14650-2201, US

(21) Appl. No.: 11/412,601

(22) Filed: Apr. 27, 2006

(51) Int. Cl. G03B 21/00

(52) U.S. Cl. 353/7

(57) ABSTRACT

An apparatus (10) for stereoscopic viewing has a first and second optical channel with a first and second display (12l, 12r) generating a first and second image and a first and second viewing lens assembly (22l, 22r) producing a virtual image, with at least one optical component of the first and second viewing lens assembly truncated (26l, 26r) along a first and second side. A reflective folding surface is disposed between the second display and second viewing lens assembly to fold a substantial portion of the light within the second optical channel. An edge portion of the reflective folding surface blocks a portion of the light in the first optical channel.

### CROSS REFERENCE TO RELATED APPLICATIONS

Reference is made to commonly-assigned copending U.S. patent application Ser. No. 11/156,119, filed Jun. 17, 2005, entitled STEREOSCOPIC VIEWING APPARATUS, by Cobb et al., the disclosure of which is incorporated herein.

### FIELD OF THE INVENTION

This invention generally relates to stereoscopic viewing devices and more particularly relates to a stereoscopic viewing apparatus having relatively large pupils, high brightness, wide field of view, and a relatively long eye relief.

### BACKGROUND OF THE INVENTION

It is widely recognized that there are significant advantages to a display apparatus that provides the capability for presenting a stereoscopic image. There have been numerous applications for stereoscopic viewing apparatus, including virtual reality systems, medical instrumentation, pilot training and information systems, for example.

A few representative examples of solutions that have been proposed for stereoscopic display are the following:
U.S. Pat. No. 5,757,546 (Lipton et al.) discloses field sequential system designed for immersion stereoscopic viewing using a single display screen;
U.S. Pat. No. 3,463,570 (Ratliff, Jr.) discloses a viewer for stereoscopic display of images from photographs;
U.S. Pat. No. 5,615,046 (Gilchrist) discloses a stereoscopic viewer having a split display screen to provide left- and right-eye images;
U.S. Pat. Nos. 4,982,278 and 4,933,755 (Dahl et al.), disclose a head-mounted device (HMD) with left-and right-eye images produced by a pair of liquid crystal (LC) displays; and
U.S. Patent Application Publication Nos. 2005/0001899 and 2004/0196553 (Banju et al.) disclose boom-mounted stereoscopic viewing apparatus particularly adapted for medical instrumentation.

As this brief partial listing of patent literature suggests, there have been a number of different approaches to the design of stereoscopic viewers utilizing both CRT and LC display devices. Boom-mounted viewers using CRT images were also disclosed by Merritt et al. in “Stereoscopic Displays and Applications” 1990, SPIE Volume 1256, pp. 136-146. An improved approach using LC devices was disclosed by Fisher et al. “Stereoscopic Displays and Virtual Reality Systems II” 1995, SPIE Volume 2409, pp. 196-199. HMD products offering stereoscopic display capabilities are commercially available from companies such as Inition, Ltd. London, UK, for example.

While there have been many proposed solutions for stereoscopic display devices, there are inherent geometrical and ergonomic limitations that are constraints on the optics design. With respect to the viewer, there is a range of values of interocular separation distance and there is a need for some amount of eye relief for viewing comfort, particularly for viewers who wear eyeglasses. For providing the best image quality, there are also requirements for high brightness, large viewing pupils, high resolution, and a wide field of view. There should be minimal crosstalk between left- and right-eye images and minimal interference from ambient light. There should be some allowance for movement of the viewer, with a stereoscopic image that can be viewed over a range of eye positions.

As is well known to those skilled in the art of stereoscopic viewer design, these requirements are often in conflict and some compromise must be achieved. In particular, there are three desirable attributes of a binocular stereoscopic viewer design that will increase the diameter of the eyepieces:
(i) large field of view;
(ii) large viewing pupil; and
(iii) extended long eye relief.

While each of desirable attributes (i), (ii), and (iii) above are best achieved with large diameter lenses, the size of the eyepiece lenses themselves are constrained by interocular separation, so that the diameter of each eyepiece can be no larger than this distance. Because of this ergonomic limitation, various compromises are made. For example, the field of view (i), pupil size (ii) and eye relief (iii) are reduced somewhat. If a large eye relief (iii) is of primary importance, a design must sacrifice both (i) and (ii), providing a smaller field of view and a smaller pupil, all to keep the lens diameters smaller than the interocular separation. Alternately, with an HMD, for example, eye relief (iii) is sacrificed in order to obtain the maximum field of view (i) without a large viewing pupil (ii). For boom-type viewing apparatus, the larger lenses needed to ease these compromises between attributes (i), (ii), and (iii) cannot be fitted together due to interocular separation.

Most HMDs, for example, are limited to providing a viewing pupil no larger than about 12 to 15 mm at best, with eye relief distances usually less than 25 mm. Other types of binocular and boom-mounted systems also are hampered in providing a larger pupil size. Typically, binocular systems, providing a small pupil size typically in the 2-3 mm range, require that the head of the viewer be positioned against a locating mechanical structure in order to fix the viewer's eyes at the correct spot. Binocular systems also provide adjustment for interocular distance.

In the attempt to maximize the field of view, vignetting effects are obtained using conventional approaches for stereoscopic viewer design. Vignetting effects with conventional stereoscopic viewing systems reduce the stereo field of view and have a wider monocular field of view. For example, each eye may see a field of view of 60 degrees, but only 40 degrees is overlapped between each eye.

Thus, although a number of solutions for boom-mounted and other portable stereoscopic viewing systems have been proposed, there is acknowledged to be considerable room for improvement, particularly with respect to enhanced image brightness, wider field of view, higher resolution, larger viewing pupil size, and larger eye relief.

### SUMMARY OF THE INVENTION

Briefly, according to one aspect of the present invention an optical apparatus for stereoscopic viewing has a first optical channel with a first display generating a first image and a first viewing lens assembly producing a virtual image, with at least one optical component of the first viewing lens assembly truncated along a first side. A second optical channel has a second display generating a second image and a second viewing lens assembly producing a virtual image, with at least one optical component of the second viewing lens assembly truncated along a second side. A reflective folding surface is disposed between the second display and second viewing lens assembly to fold a substantial portion of the light within the second optical channel. An edge portion of the reflective folding surface blocks a portion of the light in the first optical channel. The first side of the first viewing assembly is disposed adjacent the second side of the second viewing lens assembly. The apparatus also has means, such as privacy films, baffles, or polarization optics, to minimize crosstalk between the first and second optical channels.

It is a feature of the present invention that it adapts the use of lens elements having a diameter in excess of the viewer's interocular distance.

It is an advantage of the present invention that it provides a large viewing pupil, large field of view, and large eye relief in a stereoscopic viewing apparatus. It is a further advantage of the present invention that it does not require shutter apparatus for providing a stereoscopic display.

Additionally, the stereoscopic viewing system of the present invention provides the aforementioned features and advantages while further minimizing image or ghost crosstalk of leakage light from one stereoscopic imaging channel to another.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a perspective view of a stereoscopic viewing apparatus according to the present invention;

FIG. 2 is a ray diagram showing the optical path for forming the left viewing pupil;

FIG. 3 is a top view showing how the left viewing pupil is formed;

FIG. 4 is a top view showing how the right viewing pupil is formed;

FIGS. 5A and 5B are plan views of viewing pupils 24l and 24r respectively;

FIG. 6 is a plan view of a lens mount according to one embodiment;

FIG. 7 is a perspective view of a lens mount according to one embodiment;

FIG. 8 is an exploded view of a lens mount according to one embodiment;

FIG. 9 is a top view depicting a crosstalk problem in which light from a display panel enters or leaks into the right viewing pupil without encountering the mirror;

FIG. 10 is a top view depicting a crosstalk problem in which light from a display panel follows unintended optical paths and enters or leaks into both the left and right viewing pupils;

FIG. 11 is a top view depicting a crosstalk problem in which light from a display panel follows unintended optical paths and enters or leaks into both the left and right viewing pupils;

FIG. 12 is a top view depicting a crosstalk problem in which light from a display panel follows unintended optical paths and enters or leaks into the left viewing pupil;

FIG. 13 is a top view depicting a crosstalk problem the general extent of light leakage from light following unintended optical paths and entering or leaking into either the left or right viewing pupils;

FIG. 14 is a top view depicting a modified stereoscopic viewing apparatus employing a privacy film as a means to reduce the crosstalk problem;

FIG. 15 is a top view depicting a modified stereoscopic viewing apparatus employing baffles as a means to reduce the crosstalk problem;

FIG. 16 is a top view depicting a modified stereoscopic viewing apparatus employing a privacy film and baffles in combination as a means to reduce the crosstalk problem;

FIG. 17 is a top view depicting a modified stereoscopic viewing apparatus employing polarization filtering as a means to reduce the crosstalk problem; and

FIG. 18 is a top view depicting a modified stereoscopic viewing apparatus employing a combination of tilting and baffles as a means to reduce the crosstalk problem.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

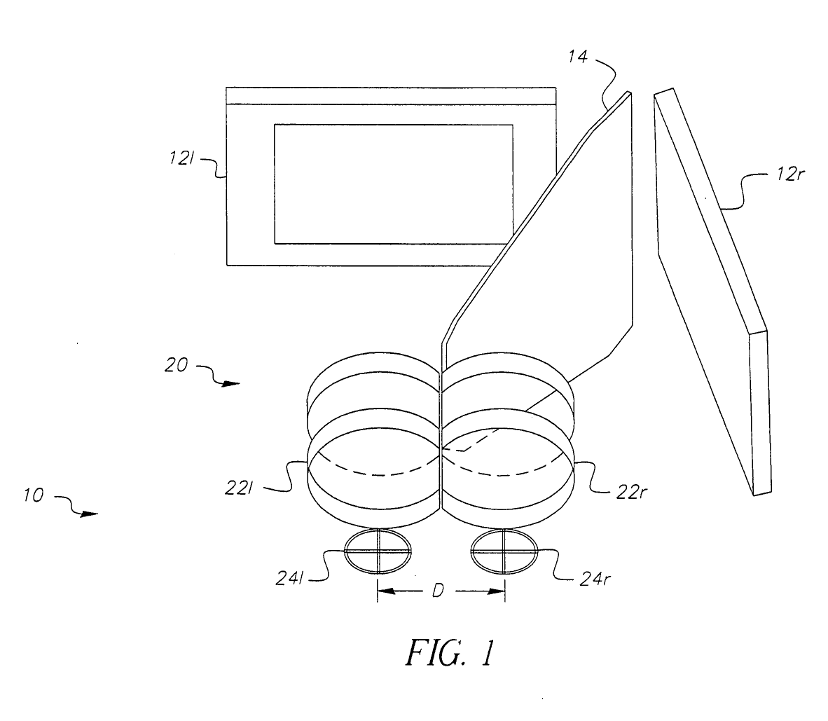

Referring to FIG. 1, there is shown a stereoscopic viewing apparatus 10 in one embodiment of the present invention. Displays 12l and 12r, typically a type of flat-panel display, provide the source left- and right-eye images. A folding mirror 14 or other type of reflective surface redirects the optical path for the right-eye image from display 12r. A viewing optical system 20 has both left and right viewing lens assemblies 22l and 22r, fitted together in a manner described subsequently. Viewing optical system 20 provides left and right viewing pupils 24l and 24r, with centers separated by an interocular distance D.

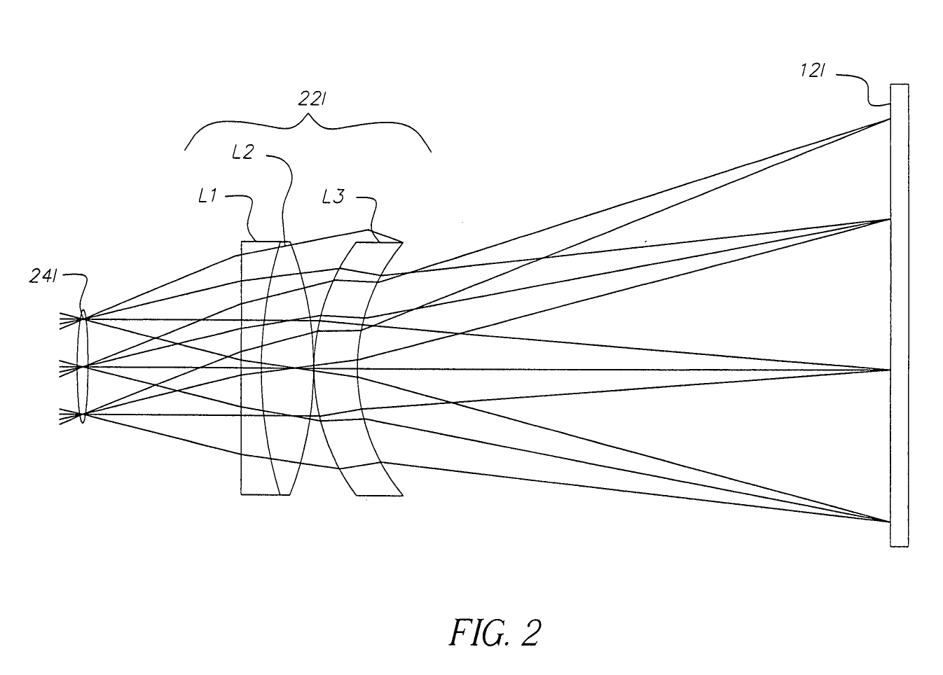

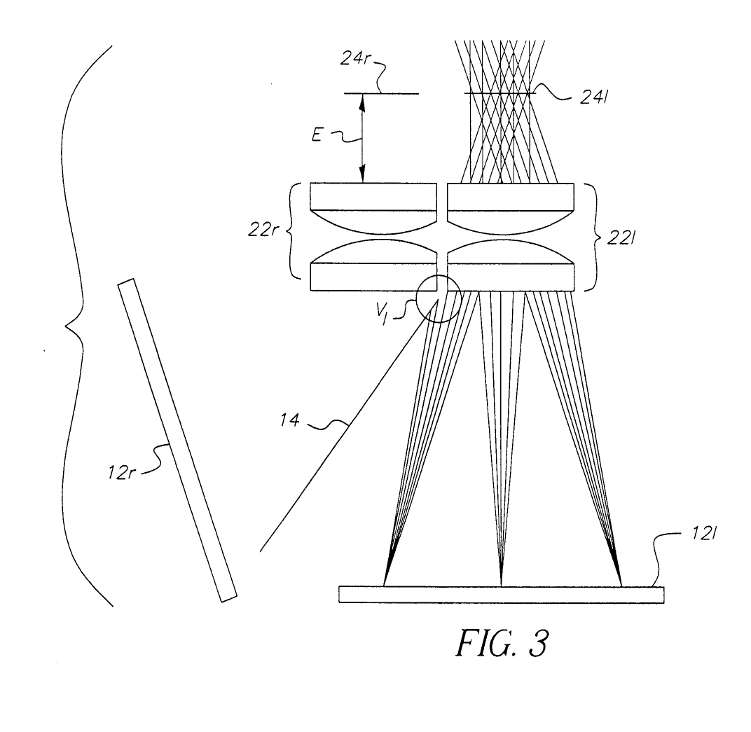

Referring to FIG. 2, there is shown the optical path for forming left viewing pupil 24l. In this embodiment, viewing lens assembly 22l has three components, lens elements L1, L2, and L3 for providing an image of display 12l. The optical path for forming right viewing pupil 24r is similar, with folding mirror 14 (see FIG. 3) between viewing lens assembly 22r and display 12r. Lenses L1 and L2 may form a cemented doublet, as shown in FIG. 2. In other embodiments, a different arrangement of lens elements L1, L2, and L3 could be used, as well as a different number of lens elements.

In the arrangement of FIG. 1, it can be observed that left and right displays 12l and 12r exceed the size of viewing pupils 24l and 24r. While this size relationship is not required (displays 12l and 12r could be smaller), there can be significant advantages in brightness and resolution when displays 12l and 12r are larger than viewing pupils 24l and 24r.

Displays 12l and 12r can be any of a number of display types. Particularly advantaged for weight and size are flat panel displays such as LC displays, including larger scale LC displays of the thin-film transistor (TFT) type. Organic LED (OLED) displays are another type of flat panel display that could be suitable. CRT or other types of displays could alternately be used for providing left- and right-eye images.

It can also be observed that at least one optical channel is folded in the apparatus of the present invention. In the arrangement of FIG. 1, the right optical channel is folded. Optionally, the left optical channel, or both left and right optical channels could include a fold mirror. Folding both channels has the advantage of simplifying the electronics in both channels. The display that lies in the folded optical path displays a mirrored image of what is ultimately to be observed by the viewer. Depending on the application, there may also be advantages relative to the depth dimension or form factor of stereoscopic viewing optical system 20.

Viewing Optical System 20

As is shown in FIG. 1, viewing optical system 20 has an arrangement of optical components for forming both left and right viewing pupils 24l and 24r. In order to provide a large viewing pupil 24l, 24r, along with a large field of view and a large eye relief, lens elements L1, L2, L3 within left and right viewing lens assemblies 22l and 22r are relatively large. In one embodiment, these lens elements are larger than 3 inches (76 mm) in diameter. However, this exceeds the interocular separation distance, which is typically in the range of about 60-70 mm for adults. Hence, in order to use lenses of this large size, one or more lens elements L1, L2, L3 of left and right viewing lens assemblies 22l and 22r is truncated along one edge, as is shown in FIGS. 3, 4, 5A and 5B. For left viewing lens assembly 22l, a truncated portion 26l is toward the right side of the aperture. For right viewing lens assembly 22r, a truncated portion 26r is toward the left side of the aperture. As a result of lens truncation, viewing lens assemblies 22l and 22r can be assembled together within a single housing, keeping left and right optical axes properly spaced at the average interocular spacing of about 64 mm.

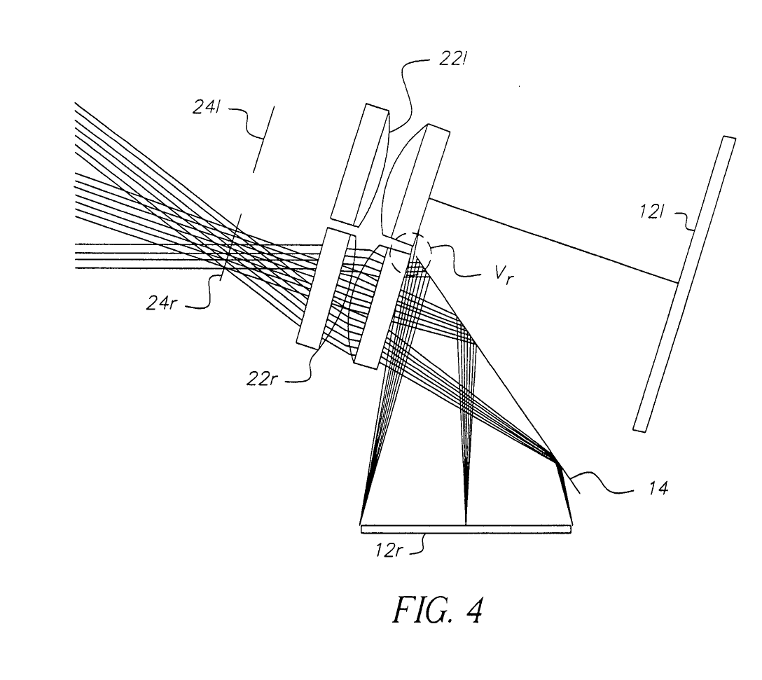

The ray diagrams in FIGS. 3 and 4 depict the imaging light that emerges from displays 12l and 12r as passing through lenses 22l and 22r respectively, such that the light encounters pupils 24l and 24r. The planes of pupils 24l and 24r are not pupil planes in the sense of lenses 22l and 22r being lens systems. Rather pupils 24l and 24r are aperture stop planes for lenses 22l and 22r. Considering again FIG. 2, the eye of a viewer is nominally placed a plane coincident with pupil 24l, which corresponds to the aperture stop of lens 22l. It is noted that the human eye nominally comprises a cornea, an intra-ocular lens, and the vitreous humor, which all contribute to the optical imaging properties of the eye. The eye also contains an internal iris or pupil (located between the cornea and intra-ocular lens), which controls the open diameter or angular acceptance of the eye. Relative to FIG. 2, a lens is shown (labeled as pupil 24l) to represent the combined optical system of the cornea, intra-ocular lens, and eye pupil. Although this eye lens is shown as filling viewing pupil 24l, it is not that the eye (cornea, iris, and intra-ocular lens) are literally the size of the viewing pupil, but that the head of a viewer can be moved around such that the eye lens can vary positionally within the viewing pupil 24l with minimal image loss. The eye lens receives the light from lens 22l that enters pupil 24l, and focuses it within the eye to create a real image (not shown) on the retina of the eye. Although panel 12l is itself smaller than the angular field of view of the eye, lens system 22l alters the light, so that it is presented to the eye in a manner that fills the eye's field of view, or nearly so. In one exemplary system, the eye was presented with a large nominal field of view of ±36 degrees from horizontal and a 30 mm viewing pupil. As a result, the eye and brain perceive an image that is much larger than the image presented on display 12l. This perceived image is a virtual image extending to infinity.

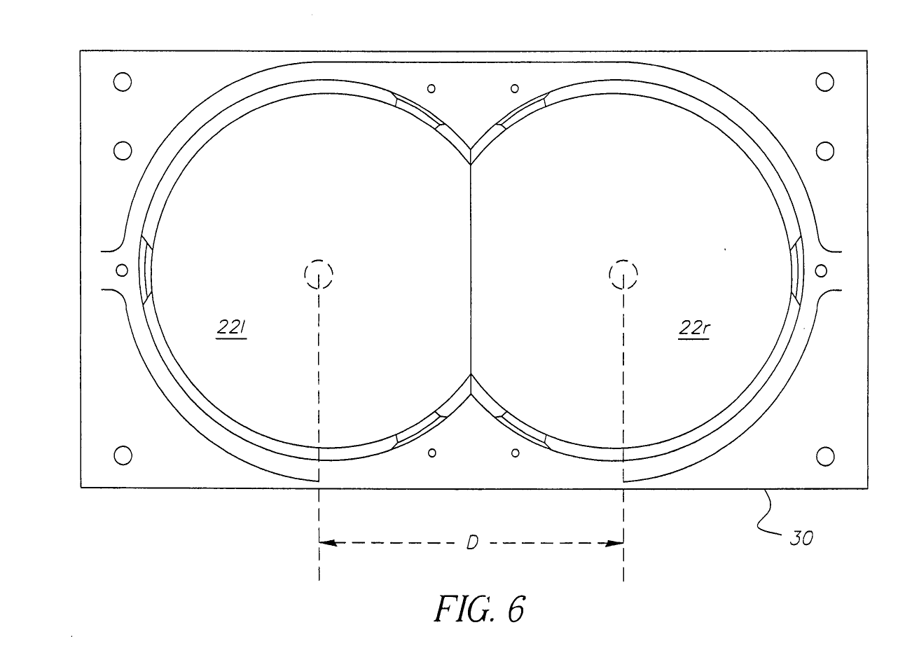

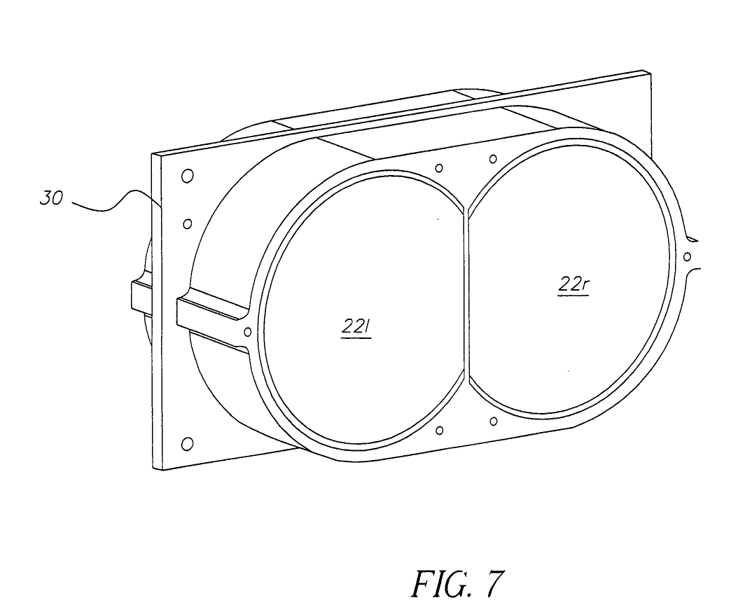

Referring to FIGS. 6, 7, and 8, there are shown a plan view, a perspective view, and an exploded view, respectively, of a lens mount 30 of viewing optical system 20 in one embodiment. Lens mount 30 provides a housing 32 for both left and right viewing lens assemblies 22l and 22r. In this embodiment, lenses L1 and L2 (a cemented doublet in the FIG. 2 embodiment) of left and right viewing lens assemblies 22l and 22r are both of a diameter exceeding the average interocular distance D and are truncated in order to fit together, as was described with reference to FIGS. 3, 4, 5A, and 5B.

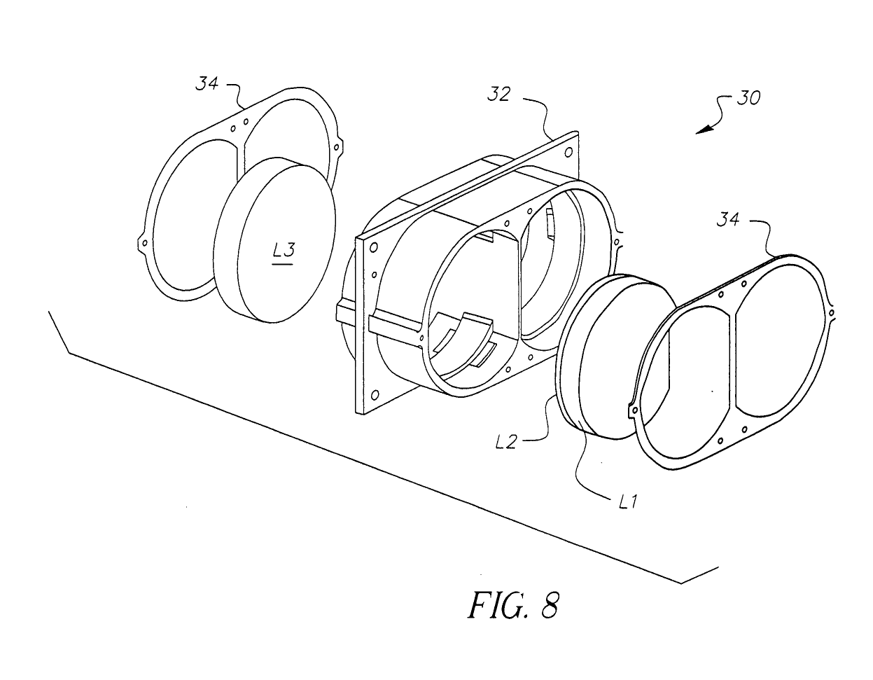

FIG. 6 shows interocular distance D between the respective optical axes of left and right viewing lens assemblies 22l and 22r. The exploded view of FIG. 8 shows assembly details in this embodiment. Lens L3 or other lenses may or may not be truncated, depending on the embodiment. The cemented assembly of lenses L1/L2 and rear lenses L3 are also shown in this exploded view. Housing 32 packages left and right viewing lens assemblies 22l and 22r as one unit. Optional retainers 34 are also shown. It is understood that any number of other possible arrangements of housing 32 and related components could be employed for packaging left and right viewing lens assemblies 22l and 22r in a single assembly.

Using relatively large lens elements enables a combination of larger left and right viewing pupils 24l and 24r, larger field of view, and an increased eye relief with respect to conventional boom-mounted and HMD stereoscopic viewing apparatus. FIGS. 3 and 4 show ray diagrams for left and right optical channels, respectively. In FIG. 3, representative rays are shown for the image generated at left display 12l. Due to the position of mirror 14 and the truncation of lens elements shown in FIG. 3, a small amount of the image is effectively vignetted, as called out by dotted circle V₁ in FIG. 3. Similarly, FIG. 4 shows representative rays for the image generated at right display 12r. A small portion of the light from one side of display 12r is not reflected from mirror 14, as called out by dotted circle Vᵣ. These vignetting effects cause some loss of pupil size for these positions in the field of view. However, it is significant to note that these vignetting effects are not in the same part of the stereoscopic field of view for left and right viewing pupils 24l and 24r. With vignetting in this manner, a full stereoscopic image is available over most of left and right viewing pupils 24l and 24r. Where vignetting occurs, the image is still visible to either the left or right eye, but that portion of the field is not stereoscopic.

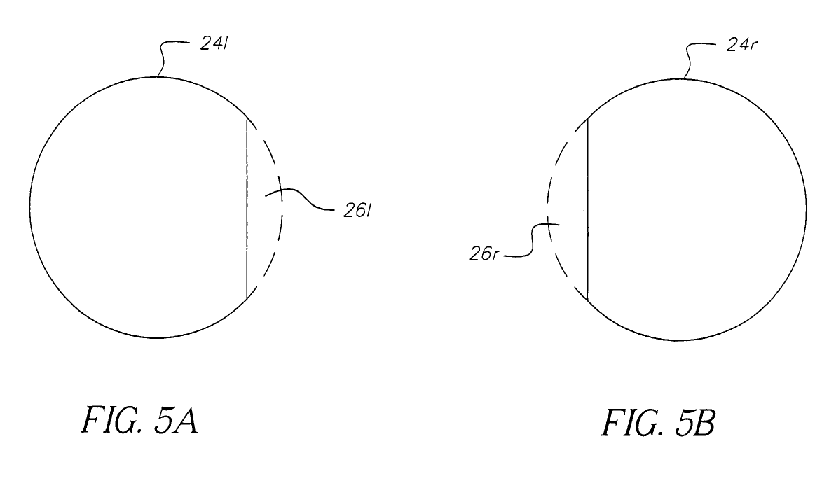

This arrangement achieves a larger effective viewing pupil 24l, 24r, even where some portion of viewing pupil 24l, 24r is not actually stereoscopic. The relative proportion of the field of view that is stereoscopic depends on the position of the viewer's eyes. If the viewer moves too far to the left or too far to the right, the complete field of view is visible, but a proportionately smaller portion of the image is stereoscopic. In effect, the size and shape of viewing pupil 24l, 24r change with the field of view. Stated differently, the entire field of view can be seen in stereo (that is, by both eyes) over some pupil area A and the same field of view can be continued to be seen in mono (that is, by one eye only) over an area outside of area A. This is illustrated in FIGS. 5A and 5B. If the viewer's eye is placed anywhere inside the truncated circular pupil 24l, 24r, the entire image field is visible. If the viewer's eye enters the truncated portion of the pupil (26l for the left eye, 26r for the right eye) then a portion of the field is vignetted. If, for example, the viewer's left eye enters the truncated portion 26l, then the viewer's right eye must be in the non-truncated portion of the right viewing pupil. With this design, the field of view is vignetted only for one eye at any given time, for any given head position.

The apparatus of the present invention provides a stereoscopic display with a comfortable amount of eye relief for the viewer (shown as dimension E in FIG. 3), a large pupil size, and a field of view larger than that provided by conventional boom-mounted stereoscopic displays. In one embodiment of a boom-mounted viewer, for example, eye relief in the 50 mm range can be obtained with a field of view of ±36 degrees from horizontal and a 30 mm viewing pupil.

The apparatus of the present invention is capable of providing very high etendue for boom-mounted stereoscopic viewing. This is particularly true since the dimension of displays 12l and 12r can be larger than the interocular separation distance D.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, there is considerable flexibility in the arrangement of optical components within left and right viewing lens assemblies 22l and 22r. Truncation of these optical components as described with reference to FIG. 1 allows for suitable interocular distance D (understood to be equivalent to the interpupil distance). The arrangement shown in FIGS. 1, 3, and 4 uses mirror 14 in the right optical channel; however, a similar arrangement would allow alternate use of mirror 14 for folding the optical path in the left optical channel, as would be readily apparent to one skilled in the optical design arts. As noted earlier, it would also be possible, in another embodiment, to fold both optical paths.

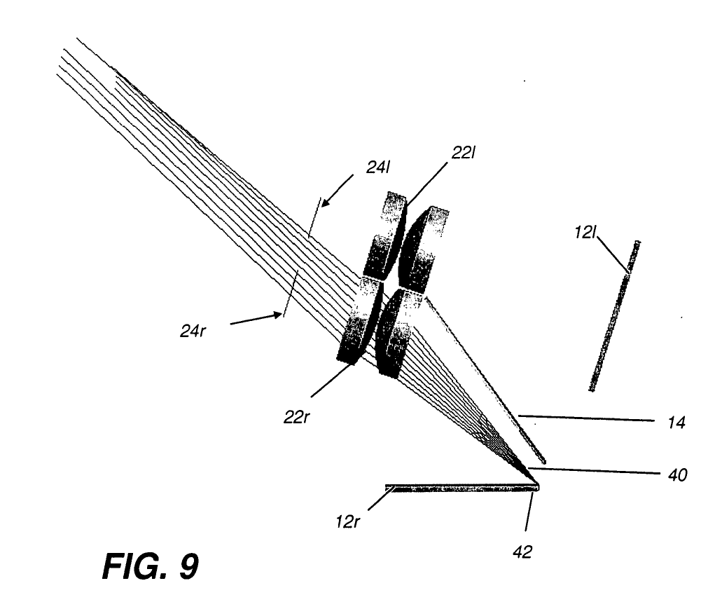

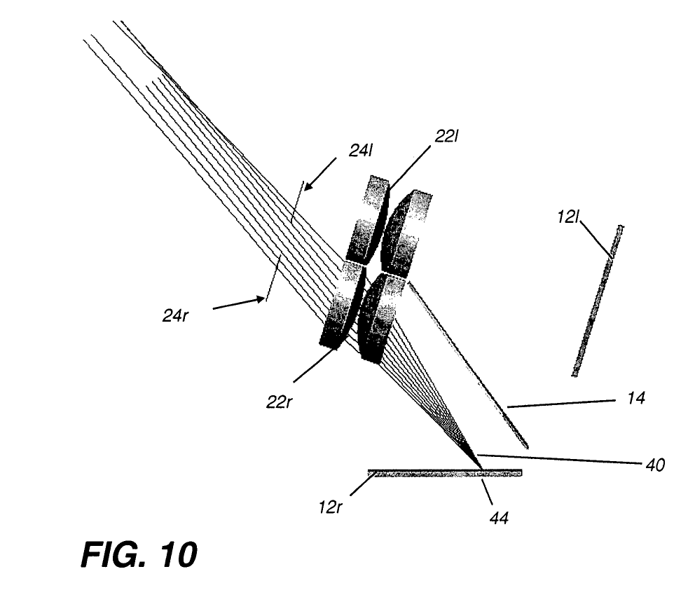

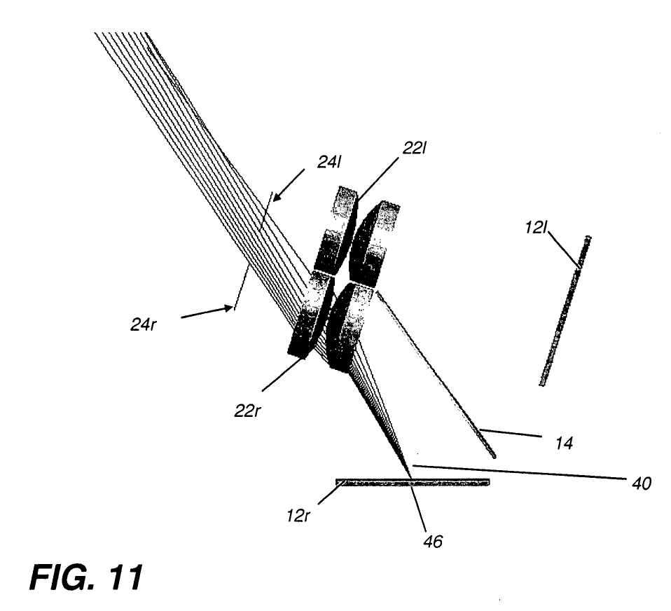

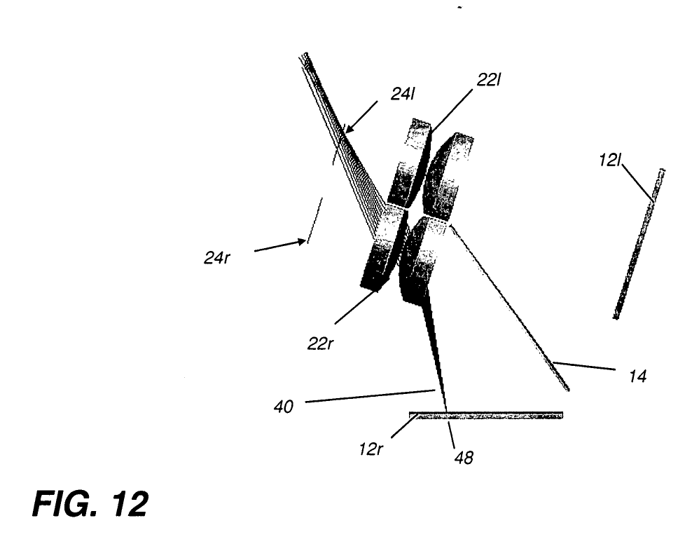

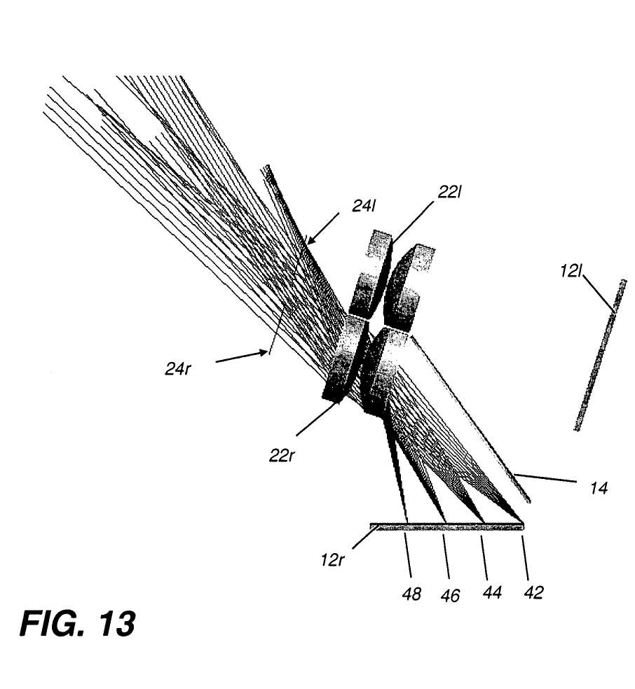

As has been described, the stereoscopic viewing apparatus 10 has been designed with emphasis on providing for high brightness and high-resolution images with large viewing pupils and a wide field of view. It has also been noted that such designs should minimize image crosstalk between the left- and right-eye images. As shown in the embodiment of FIG. 4, the primary viewed image from display 12r occurs by reflection off of mirror 14 and into viewing pupil 24r. However, FIG. 4 does not depict a previously unanticipated problem of crosstalk or leakage of light from display 12r entering into viewing pupils 24r and 24l. As a first example, FIG. 9 shows that light from an inner edge (near mirror) position 42 of display 12r can directly enter viewing pupil 24r without reflecting off of mirror 14. This light, which is high angle light (or skew rays) that was emitted by panel 12r, becomes a leakage light 40 that has basically followed unintended optical paths to reach pupil 24r. As a second example, FIG. 10 shows that leakage light 40 from position 44, which is near the inner edge of display 12r, can directly enter both viewing pupils 24r and 24l without reflecting off of mirror 14. As a third example, FIG. 11 shows that leakage light 40 from center position 46 on display 12r directly enters viewing pupil 24l. As a fourth example, FIG. 12 shows that leakage light 40 from a position 48 near the outer edge of display 12r likewise directly enters viewing pupil 241. FIG. 13 shows the distribution of crosstalk or leakage light from all of the aforementioned positions 42, 44, 46, and 48 on to viewing pupils 24r and 24l. This crosstalk can also cause tertiary images, flare light, or ghost reflections from light that bounces around within viewing lens assemblies 22l and 22r. For example, significant crosstalk or leakage light 40 has been observed in a stereoscopic viewing apparatus 10 equipped with two 16.1 cm diagonal TFT color LCD displays from NEC Corporation. These panels have a native light emission extending out beyond ±60° from the surface normal, which is sufficient to cause the leakage light problem.

This crosstalk or leakage light creates ghost images that can be perceived by a viewer. In general, these ghost images, which can occur in one or both of the viewing pupils 24l and 24r, are only distractions for a viewer, as the ghost images are dim as compared to the primary images. Additionally, these ghost images occur at the edge of the viewer's field of view, or in the peripheral vision, and thus a viewer generally does not perceive these images unless he (or she) redirects their line of sight to look at it. These ghost images may also be somewhat defocused and aberrated as compared to the primary images. However, these ghost images can be a real and significant distraction nonetheless. Both the primary image and the distracting secondary ghost image are real images at the retina of the eye. The primary image of the system and the secondary distraction image are not seen at the same time, but the secondary image can be enough of a distraction as to cause the viewer to change their viewing of the primary image to look at the secondary distraction image.

There are several solutions to solve this crosstalk or leakage light problem. Of course, the display devices selected for displays 12r and 12l could be specified to have a reduced angular emission as compared to the typical devices offered by the display industry, which are often optimized to provide wide viewing angles. However, custom devices may then be required, which could raise the cost of the stereoscopic viewing apparatus 10. Additionally, merely reducing the display emission angle may not be sufficient or desirable, as the angles of emitted light that contribute to leakage vary across the panel, as was discussed in relation to FIG. 13.

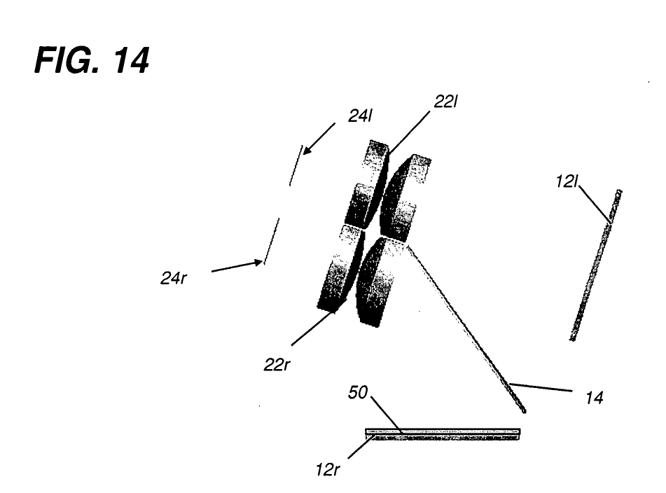

One method is to put a privacy film 50 on the front of display 12r, as shown in FIG. 14. For example, a privacy film, such as PF14.1 or PF 400 can be obtained from 3M Inc. In general, a privacy film uses molded louvers to block (or absorb) high angle light and thereby reduces the viewing angle of the light emitted by the display. In effect, the louvers simulate a tiny Venetian blind, blocking out and controlling the direction of off axis display light. The louvers can provide a total cut-off past the viewing angle. In the case of the present invention, display 12r is equipped with a privacy film 50 that reduces the high angle or off axis light effectively emitted by the display 12r, such that that light is not present to then encounter lens assembly 22r and thereby become leakage light. As a result, the presence of crosstalk or leakage light is greatly reduced. While commercially available privacy films can be used, it may also be desirable to provide a custom privacy film for this system. In the extreme, this privacy film could have a spatially variant pattern of angular control across its surface.

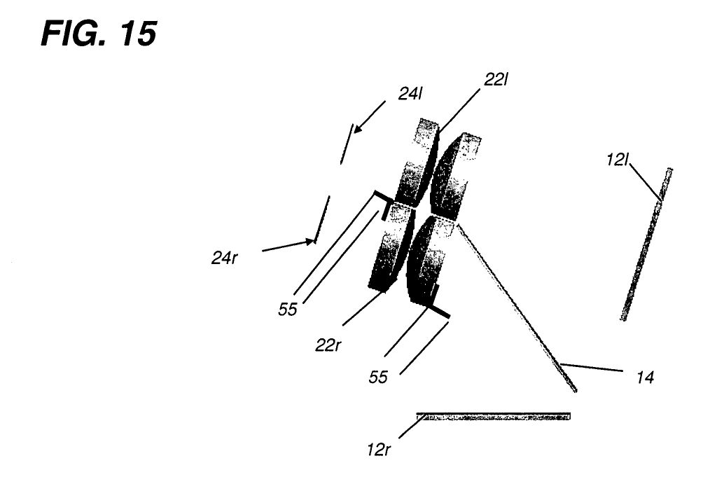

Another method for greatly reducing crosstalk/light leakage is by placing a plurality of baffles 55 in various locations, as shown in FIG. 15. The baffles 55 should preferably be made out of (or coated with) a material that is light absorbing so as to minimize reflections. The baffles can also have roughened surfaces to increase the light trapping at the surfaces. In general, the baffles are used to both obstruct and absorb the leakage light. The baffle 55 which is in proximity to viewing pupils 24l and 24r may need to be adjustable in length, or otherwise designed to minimize and ergonomically optimize the interaction of the baffle with the face of a viewer. That is, the baffle 55 could be an adjustable nosepiece.

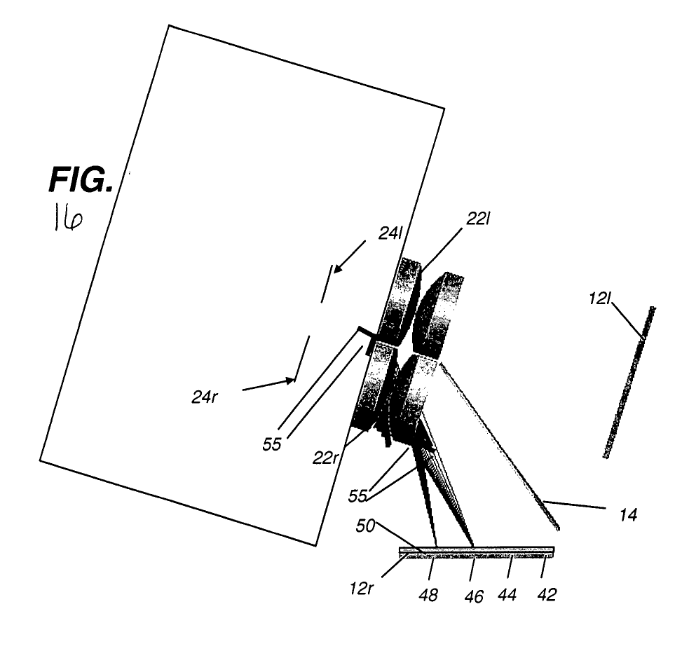

Also, the combination of the privacy film and baffles used together will be more effective for reducing or possibly eliminating the crosstalk/light leakage affecting viewing pupils 24l and 24r. As seen from FIG. 16, the privacy screen 50 allows the low angle light from center position 46 and near outer edge position 48 to be transmitted, but will block the high angle light that is emitted from inner edge position 42 and near inner edge position 44. The lower angle light emitted from center position 46 and near outer edge position 48 are then most effectively blocked by use of the baffles 55 in a plurality of locations. This combination of baffles 55 and privacy film 50 compensates for the fact that the privacy film 50 has a spatially uniform angular response that is not adequate for all positions. Stereoscopic viewing apparatus 10 could also be equipped with a field lens (not shown) positioned proximate to the display 12r to modify the angular directionality of the emitted light. The use of a field lens could be particularly useful in the case that the panel 12r display device has a relatively narrow native light emission.

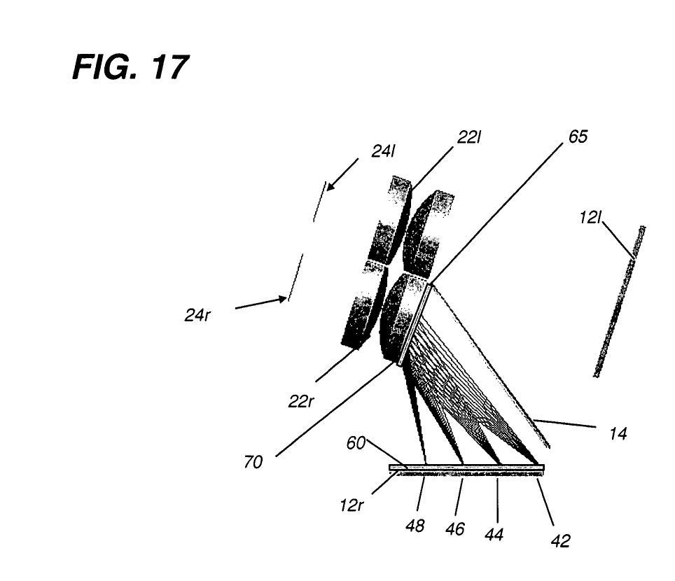

Another method to reduce or eliminate crosstalk/light leakage is by the use of polarization. For example, as shown in FIG. 17, stereoscopic viewing apparatus 10 can be further equipped with a waveplate 60 and a polarizer 65. Note that the light emitted from display 12r is already linearly polarized. By placing a wave plate 60, which is nominally a quarter waveplate, on display 12r, the light can be chosen to become either circularly polarized in left handed or right handed polarization. When the light reflects off of the mirror (which can be either a dielectric coated or metal mirror), the orientation of the polarization becomes reversed. For example, right-handed polarization light will become left-handed polarized light and vice versa. In greater detail, as shown in FIG. 17, linear polarized light emerges from display 12r and encounters waveplate 60, which is oriented at a nominal 45° rotation from the linear polarization axis. As a result, right hand circularly polarized light emerges from the panel/waveplate combination. The right hand circularly polarized light which encounters mirror 14 becomes left handed circularly polarized and passes through a circular blocking polarizer 65 and proceeds to lens 22r and pupil 24r. By comparison, right hand circularly polarized leakage light 40 from the various panel positions (42, 44, 46, and 48) propagates forward to encounter circular blocking polarizer 65, which is mounted on the input side surface 70 of lens assembly 22r. In this example, circular blocking polarizer 65 would be a right hand circular polarizer that attenuates right handed circularly polarized light. This circular blocking polarizer itself can comprise a combination of a quarter wave plate and a linear polarizer. As a result, the right handed circularly polarized direct view light is attenuated and crosstalk is reduced. This filter may be provided with anti-reflection coatings to minimize flare from Fresnel surface reflections. Baffles (55, but not shown) could also be added to the system of FIG. 17. Note that polarizer 65 can also be located on the output side of lens assembly 22r, or even within the assembly, but locating polarizer 65 just prior to the lens (at input surface 70) is preferred, as it reduces the chance for ghosts and flare light to be generated within the lens.

As another alternative, the stereoscopic viewing apparatus 10 can be constructed with a polarizer 65, as shown in FIG. 17, but without the waveplate 60 shown in that figure. In this case, linear polarized light which is emitted by display 12r, and which encounters mirror 14, while traversing the optical path to become image light, has its polarization state rotated by the encounter with the mirror. In particular, for example, if the emergent polarization state is at a +45° orientation with respect to the panel (i.e., oriented along a panel diagonal) then the polarization state of this light is rotated to the orthogonal −45° orientation upon reflecting from mirror 14. Polarizer 65 is then oriented at this same −45° orientation so as to allow image light to transmit through to lens assembly 22r. In contrast, the potential leakage light which was emitted by display 12r and which travels directly towards input surface 70 without encountering mirror 14 still has the native initial +45° orientation and is then blocked by the −45° orientated polarizer 65. This approach does not work if the display 12r has a native polarization orientation that is aligned with either the long axis or short axis of the display device, as the polarization orientation is not then rotated by the mirror reflection. However, if the native polarization orientation of the panel is aligned with either the long axis or short axis of the display device and not at ±45°, the stereoscopic viewing apparatus 10 could again be equipped with a waveplate (nominally a half waveplate) 60 at display 12r to rotate the polarization state to either +45° or −45°. It is noted that the polarization orientations of the high angle (and skew) rays may not be purely aligned to a native polarization orientation (such as +45°). Thus the reduction of leakage light could vary in a significant way across the panel, and other approaches, such as baffles 55 may yet be needed. Also, if the native polarization state emitted by display 12r varied in a significant way spatially across the panel, then again this approach may not work or may be compromised.

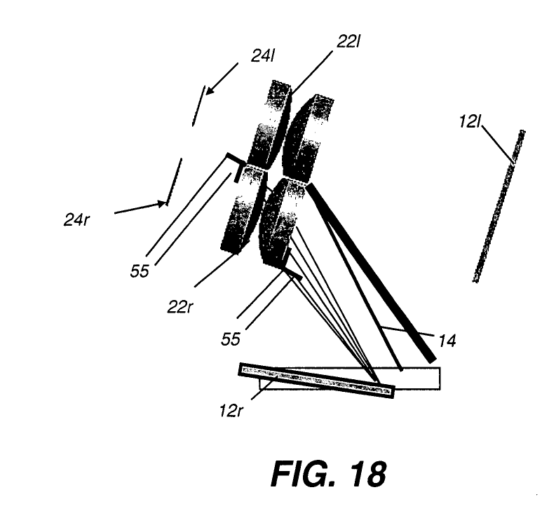

Another method to reduce or eliminate crosstalk/light leakage is by reorienting the display 12r and mirror 14 such that the primary image reflected from mirror 14 is still transmitted fully into viewing pupil 24r, but such that the angular range of light transmitted from display 12r directly into pupils 24r and 24l is greatly reduced or eliminated. In the prior embodiments, as shown in FIG. 4 and FIGS. 9-17, mirror 14 is nominally tilted at 45° relative to the optical axes of lenses 22l and 22r. As shown in FIG. 18, by rotating the display 12r and the mirror 14 away from display 12l, the crosstalk/light leakage is greatly reduced into 24r. For example, these components may be rotated such that mirror 14 ends up tilted at ˜55° relative to the optical axes of lenses 22l and 22r. There might still be crosstalk/light leakage into pupil 24l, which may be further reduced or eliminated by the addition of a privacy film and/or a plurality of baffles.

In the prior discussion, the concern has been about the crosstalk of leakage light from display 12r into viewing pupils 24l and 24r. However, the potential for crosstalk from display 12l should be clarified. In the case that display 12l is positioned orthogonal to the optical axis of lens 22l (as first shown in FIG. 3), possible leakage light from the inner edge of display 12l is blocked by the back surface of mirror 14, preventing it from passing through lens assembly 22r. Potential leakage light from the outer edge of display 12l heads away from the lens system entirely, and propagates into the housing (not shown) of the stereoscopic viewing apparatus 10. As long as this housing has light traps or non-reflecting surfaces, this light should not reenter the optical system as flare light. On the other hand, if display 12l is provided with its own mirror 14, then leakage could occur for this half as well, and corrective measures would be needed.

Thus, what is provided is an apparatus and method for stereoscopic viewing with relatively large pupils, relatively large fields of view, relatively long eye relief, and high brightness, while further reducing crosstalk between image channels to minimal levels. Of course it is preferable to reduce the ghost images from the crosstalk leakage light to negligible levels. However, in practice, some residual leakage light can be tolerated if it is low enough as to basically be ignored under all or most circumstances. For example, if the secondary ghost image is reduced to residual average light levels that are ˜ 1/500^{th} the magnitude of the primary image, the reduction of the leakage light is probably acceptable. The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention.

### PARTS LIST

10 stereoscopic viewing apparatus
12l left display
12r right display
14 mirror
20 viewing optical system
21l left viewing lens assembly
22r right viewing lens assembly
24l left viewing pupil
24r right viewing pupil
26l left truncated portion
26r right truncated portion
30 lens mount
32 housing
34 retainer
40 leakage light
42 inner edge position
44 near inner edge position
46 center position
48 near outer edge
50 privacy film
55 baffles
60 waveplate
65 polarizer
70 input surface

1. An optical apparatus for stereoscopic viewing comprising:
a) a first optical channel comprising:
i) a first light emitting display for generating a first image;
ii) a first viewing lens assembly for producing a virtual image of said first display and directing light toward a first viewing pupil;
wherein at least one optical component of the first viewing lens assembly is truncated along a first side;
b) a second optical channel comprising:
i) a second light emitting display for generating a second image;
ii) a second viewing lens assembly for producing a virtual image of said second display and directing light toward a second viewing pupil;
wherein at least one optical component of the second viewing lens assembly is truncated along a second side;
iii) a first reflective folding surface disposed between the second display and the second viewing lens assembly to fold a substantial portion of light within the second optical channel;
wherein an edge portion of said first reflective folding surface blocks a portion of the light in the first optical channel;
wherein the first side of the first viewing lens assembly is disposed adjacent the second side of the second viewing lens assembly; and
c) means for minimizing crosstalk light from the second panel entering the first viewing pupil, the second viewing pupil, or both.

2. The optical apparatus as in claim 1 wherein said means for minimizing crosstalk comprises a privacy film, which reduces the amount of high angle light, one or more baffles which reduce the amount of leakage light, or the use of said privacy film and said baffles in combination.

3. The optical apparatus as in claim 1 wherein said means for minimizing crosstalk comprises a polarization filtering means, which includes a quarter wave plate and a polarizer which attenuates a given handedness or orientation of circularly polarized light.

4. The optical apparatus as in claim 1 wherein said means for minimizing crosstalk comprises a linear polarizer located with said second viewing lens assembly, and in which said second panel emits linear polarized light nominally oriented along a panel diagonal, such that said linear polarized light has its polarization state rotated to the orthogonal orientation by reflection from said mirror, with the result that said reflected linear polarized light is transmitted through said linear polarizer, while polarized light emitted by said second panel that encounters said linear polarizer without having encountered said mirror is then attenuated.

5. The optical apparatus as in claim 1 wherein said means for minimizing crosstalk is provided by having said second optical channel tilted at an angle greater than 45 degrees relative to the optical axis of said second viewing lens assembly and in which one or more baffles are used to further reduce the amount of leakage light.

6. The optical apparatus of claim 1 wherein the first optical channel further comprises a second reflective folding surface disposed between the first display and the first viewing lens assembly to fold a substantial portion of the light within the first optical channel.

7. The optical apparatus of claim I wherein the outer diameters of the first and second viewing lens assemblies are larger than the separation distance between the respective optical axes of the first and second lens assemblies.

8. The optical apparatus of claim 1 wherein the first viewing pupil is a right-eye viewing pupil.

9. The optical apparatus of claim 1 wherein the first viewing pupil is a left-eye viewing pupil.

10. The optical apparatus of claim 1 wherein at least one optical component of the first viewing assembly has a diameter exceeding 64 mm.

11. The optical apparatus of claim 1 wherein the first and second viewing lens assemblies are mounted within the same housing.

12. The optical apparatus of claim 1 wherein the first display is a liquid crystal device (LCD).

13. The optical apparatus of claim 1 wherein the first display is an organic light emitting diode device (OLED).

14. The optical apparatus of claim 1 wherein the first display comprises a cathode ray tube (CRT).

15. An optical apparatus for stereoscopic viewing comprising:
a) a first optical channel comprising:
i) a first light emitting display for generating a first image;
ii) a first viewing lens assembly for producing a virtual image of said first display and directing the light toward a first viewing pupil;
b) a second optical channel comprising:
i) a second light emitting display for generating a second image;
ii) a second viewing lens assembly for producing a virtual image of said second display and directing the light toward a second viewing pupil;
iii) a first reflective folding surface disposed between the second display and the second viewing lens assembly to fold a substantial portion of said light within the second optical channel;
wherein the first side of the first viewing lens assembly is disposed adjacent the second side of the second viewing lens assembly; and
c) means for minimizing crosstalk light from the second panel entering the first viewing pupil, the second viewing pupil, or both.

16. The optical apparatus as in claim 15 wherein said means for minimizing crosstalk comprises a privacy film, which reduces the amount of high angle light, one or more baffles which reduce the amount of leakage light, or the use of said privacy film and said baffles in combination.

17. The optical apparatus as in claim 15 wherein said means for minimizing crosstalk comprises a polarization filtering means, which includes a quarter wave plate and a polarizer which attenuates a given handedness or orientation of circularly polarized light.

18. The optical apparatus as in claim 15 wherein said means for minimizing crosstalk is provided by having said second optical channel tilted at an angle greater than 45 degrees relative to the optical axis of said second viewing lens assembly and in which one or more baffles are used to further reduce the amount of leakage light.

19. The optical apparatus as in claim 15 wherein said means for minimizing crosstalk comprises a linear polarizer located with said second viewing lens assembly, and in which said second panel emits linear polarized light nominally oriented along a panel diagonal, such that said linear polarized light has its polarization state rotated to the orthogonal orientation by reflection from said mirror, with the result that said reflected linear polarized light is transmitted through said linear polarizer, while polarized light emitted by said second panel that encounters said linear polarizer without having encountered said mirror is then attenuated.

20. The optical apparatus of claim 15 wherein the first optical channel further comprises a second reflective folding surface disposed between the first display and the first viewing lens assembly to fold a substantial portion of the light within the first optical channel.

21. The optical apparatus of claim 15 wherein the outer diameters of the first and second viewing lens assemblies are larger than the separation distance between the respective optical axes of the first and second lens assemblies.

22. An optical apparatus for stereoscopic viewing comprising:
a) a first optical channel comprising:
i) a first display which emits light representing a first image;
ii) a first viewing lens assembly for producing an image of said first display in an eye of a viewer by presenting light toward a first viewing pupil;
b) a second optical channel comprising:
i) a second display which emits light representing a second image;
ii) a second viewing lens assembly for producing an image of said second display in an eye of a viewer by presenting light toward a second viewing pupil;
iii) a first reflective folding surface disposed between the second display and the second viewing lens assembly to fold a substantial portion of said light within the second optical channel;
wherein the first side of the first viewing lens assembly is disposed adjacent the second side of the second viewing lens assembly; and
c) means for minimizing crosstalk light from the second panel entering the first viewing pupil, the second viewing pupil, or both.

23. The optical apparatus as in claim 22 wherein said means for minimizing crosstalk comprises a privacy film, which reduces the amount of high angle light, one or more baffles which reduce the amount of leakage light, or the use of said privacy film and said baffles in combination.

24. The optical apparatus as in claim 22 wherein said means for minimizing crosstalk comprises a polarization filtering means, which includes a quarter wave plate and a polarizer which attenuates a given handedness or orientation of circularly polarized light.

25. The optical apparatus as in claim 22 wherein said means for minimizing crosstalk is provided by having said second optical channel tilted at an angle greater than 45 degrees relative to the optical axis of said second viewing lens assembly and in which one or more baffles are used to further reduce the amount of leakage light.

26. The optical apparatus as in claim 22 wherein said means for minimizing crosstalk comprises a linear polarizer located with said second viewing lens assembly, and in which said second panel emits linear polarized light nominally oriented along a panel diagonal, such that said linear polarized light has its polarization state rotated to the orthogonal orientation by reflection from said mirror, with the result that said reflected linear polarized light is transmitted through said linear polarizer, while polarized light emitted by said second panel that encounters said linear polarizer without having encountered said mirror is then attenuated.

27. The optical apparatus of claim 22 wherein the first optical channel further comprises a second reflective folding surface disposed between the first display and the first viewing lens assembly to fold a substantial portion of the light within the first optical channel.
